(19) United States
(12) Patent Application Publication
(10) Pub. No.: US 2020/0376450 A1
(43) Pub. Date: Dec. 3, 2020

(54) MIXER FOR DEF

(71) Applicant: FAURECIA SYSTEMES D'ECHAPPEMENT, NANTERRE (FR)

(72) Inventors: Laurent POINSOT, MONTBELIARD (FR); Ludovic GEANT, RIOZ (FR)

(21) Appl. No.: 16/886,892

(22) Filed: May 29, 2020

(30) Foreign Application Priority Data
May 29, 2019 (FR) FR 19 05764

(51) Int. Cl. B01F 5/06; F01N 3/20; F01N 3/28; B01F 3/04; B01D 53/94

(52) U.S. Cl. CPC B01F 5/061; F01N 3/2066; F01N 3/2892; B01F 2005/0017; B01D 53/9418; B01F 2005/0621; B01F 3/04021

(57) ABSTRACT

A mixer for mixing a fluid solution, such as a diesel exhaust fluid for selective catalytic reduction, with a gas, such as an exhaust gas, includes a mixing chamber with a general cylinder shape obtained by translation of a polarly period section along a first axis. The fluid solution is sprayed in the mixing chamber by way of a first axial end thereof. The gas enters the mixing chamber through openings formed in a generatrix surface of said mixing chamber, and the mixture exits through a second axial end opposite the first axial end. The polarly period section is shaped in a star, obtained by polarly periodically repeating an elementary profile, comprising an opening defined by a first angle between a first segment passing through the two ends of said opening and a radial line passing through the distal end of said first segment.

### CROSS REFERENCE TO RELATED APPLICATIONS

This application is a U.S. non-provisional application claiming the benefit of French Application No. 19 05764, filed on May 29, 2019, which is incorporated herein by its entirety.

### TECHNICAL FIELD

The present disclosure relates to the technical field of exhaust lines, and more specifically to mixers for mixing a fluid solution such as a diesel exhaust fluid (DEF), or gaseous ammonia, to produce a selective catalytic reduction, with the exhaust gas.

### BACKGROUND

It is known from the prior art to produce and use a mixer for mixing a fluid solution, such as a diesel exhaust fluid for selective catalytic reduction, typically comprising urea in liquid form and ammonia in gaseous form, with a gas, such as an exhaust gas. Said mixer is typically located in an exhaust line coupled to an internal combustion engine, preferably of the diesel type. Said mixer comprises a mixing chamber with a general cylinder shape, obtained by translating a polarly periodic section along a first axis. The fluid solution is sprayed, in aerosol form for a liquid and in gaseous form for a gas, in an axial end of the mixing chamber. The gas enters the mixing chamber through openings formed in a generatrix surface of said mixing chamber. The resulting mixture, mixed gas and liquid fluid, leaves through the other axial end.

Owing to the section of the mixing chamber, and particularly the orientation of the openings, when the gas enters the mixing chamber, the gas is subject to a swirling movement. The purpose of this swirling is first to assist the mixing operation of the fluid solution with the gas, and second to prevent or at least limit the deposition of the liquid part contained in the fluid solution on the inner surfaces of the mixing chamber. To achieve this aim, the swirling must be substantially uniform in a section perpendicular to the axis of the mixing chamber and have a fairly specific rotation rate, not too slow, not too fast. A non-uniform swirling would lead to spraying droplets of the fluid solution on a certain side of a wall of the mixing chamber, leading to an accumulation of liquid. One way to obtain a uniform swirling rotation speed inside the mixing chamber is to improve the balance of the mass flow rate speeds at each opening of the mixing chamber. This can be obtained by reducing the opening size, causing an increase of the pressure upstream from the mixing chamber and an increase of the velocity at the openings of the mixing chamber. This will increase the rotation rate of the swirling. This could also lead to early spraying of droplets by centrifugal effect on the walls of the mixing chamber, and thus a deteriorated performance. The polarly periodic section is, in the best case scenarios, conformed in a spiral. Such a spiral shape is difficult to adjust to obtain a uniform vortex having the proper gas speed. Additionally, since such a spiral comprises curved wings, a spiral-shaped mixing chamber is difficult to manufacture.

The shapes of the mixing chambers of the prior art cannot achieve the objectives to provide a good mixing chamber.

### SUMMARY

It has been discovered that an improved mixing chamber comprises a star-shaped section, which addresses the aforementioned problems in a satisfactory manner. Such a star-shaped section could be obtained by polarly periodically repeating an elementary profile, comprising an opening defined by a first angle between a first segment passing through the two ends of said opening and a radial line passing through the distal end of said first segment.

Specific features or embodiments, usable alone or in combination, are:
said elementary profile comprises substantially only rectilinear segments,
the number of periodic repetitions is between 2 and 20, preferably between 4 and 16, still more preferably between 6 and 12,

i. said number is a prime number, preferably 7 or 11,

ii. said first angle is between 0 and 90°, preferably between 10 and 80°, still more preferably between 15 and 50° and even more preferably between 15 and 45°,
said elementary profile comprises said segment comprising the opening,
said elementary profile further comprises a second segment, adjacent to the first segment and oriented relative to said first segment by a second angle,
said second angle is between 45 and 90°, preferably between 60 and 90° and still more preferably between 70 and 90° when the elementary profile comprises two segments,
said elementary profile further comprises a third segment, adjacent to the second segment and oriented relative to said second segment by a third angle,
said second angle is between 45 and 180°, preferably between 80 and 180° and still more preferably between 90 and 180° when the elementary profile comprises more than two segments,

iii. said third angle is between 90 and 180°, and preferably between 100 and 180°,
the generatrix surface is manufactured from a single sheet of metal, cut to obtain the openings, bent to form the segments and assembled edge to edge in order to close the generatrix surface.

### BRIEF DESCRIPTION OF THE DRAWINGS

The disclosure will be better understood upon reading the following description, provided solely as an example, and in reference to the appended figures, in which:

FIG. 1 shows, in perspective view, a mixer,

FIG. 2 shows, in perspective view, a first embodiment of a star-shaped section,

FIG. 3 shows, in sectional view, the same first embodiment,

FIG. 4 shows, in sectional view, the parameters for defining a star-shaped section,

FIG. 5, FIG. 6, and FIG. 7 show three other embodiments of star-shaped sections and their corresponding velocity diagram,

FIG. 8 shows an exemplary sheet manufactured to produce a mixing chamber.

### DETAILED DESCRIPTION

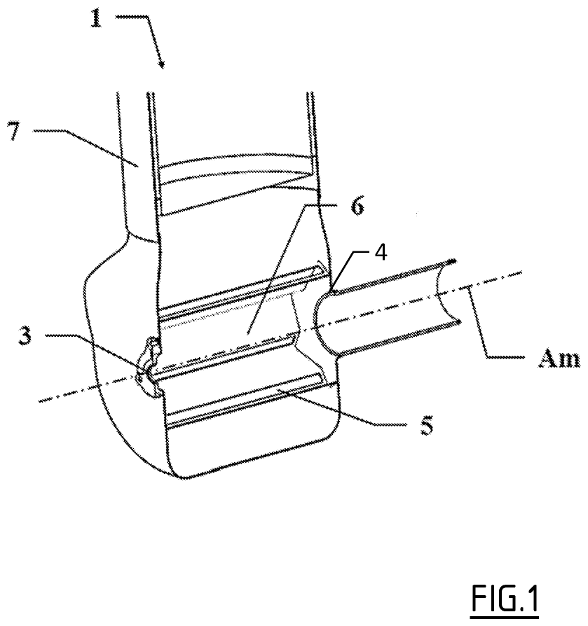

In reference to FIG. 1, showing a cut perspective view, a mixer 1 comprises a mixing chamber 2. Said mixing chamber 2 has a general cylinder shape, that is to say, obtained by translation of a section S, here a polarly periodic section S, along a first axis Am. Said translation is preferably perpendicular to the section S. Said general cylinder then comprises a first axial end 3 on one side of said axis Am, a second axial end 4 opposite the first axial end 3 on the other side of said first axis Am and a generatrix surface 6 surrounding said first axis Am.

The fluid solution, such as a diesel exhaust fluid (DEF) for selective catalytic reduction (SCR), which is made up of an aqueous solution of urea and ammonia gas, is sprayed in aerosol form for the liquid part and in gas form for the gaseous part in the mixing chamber 2 through the first axial end 3.

The gas, such as an exhaust gas, enters the mixer 1 through an inlet line 7. Then the gas enters the mixing chamber 2 through openings 5 formed in the generatrix surface 6 of said mixing chamber 2.

In the mixing chamber 2, gas and fluid are mixed and the produced mixture exits through the second axial end 4.

A good mixture is obtained when the shape of the mixing chamber 2, and particularly its generatrix surface 6, leads the gas to form a vortex in the mixing chamber 2. Said vortex must be as uniform as possible in a section perpendicular to the axis Am of the mixing chamber, both polarly and radially, so as to have a substantially specific rotation speed in the entire volume of the mixing chamber 2. Furthermore, said rotation speed must have an adequate value, not too low or too high. This is first to ensure good mixing, and second to prevent the liquid part of the fluid solution from being deposited on the inner surface of the mixing chamber 2.

In order to adjust both the shape of the vortex and the intensity of the value of the rotation speed, preferably separately, it is of great interest to have a parametric design with parameters that can be adapted, preferably by simulation, until an optimal vortex is obtained.

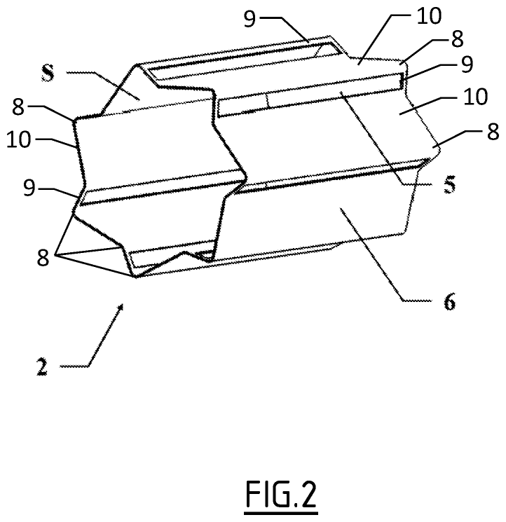

For these reasons, according to the disclosure, said section S of the mixing chamber 2 is shaped in a star. A first embodiment is illustrated in FIG. 2, in perspective view.

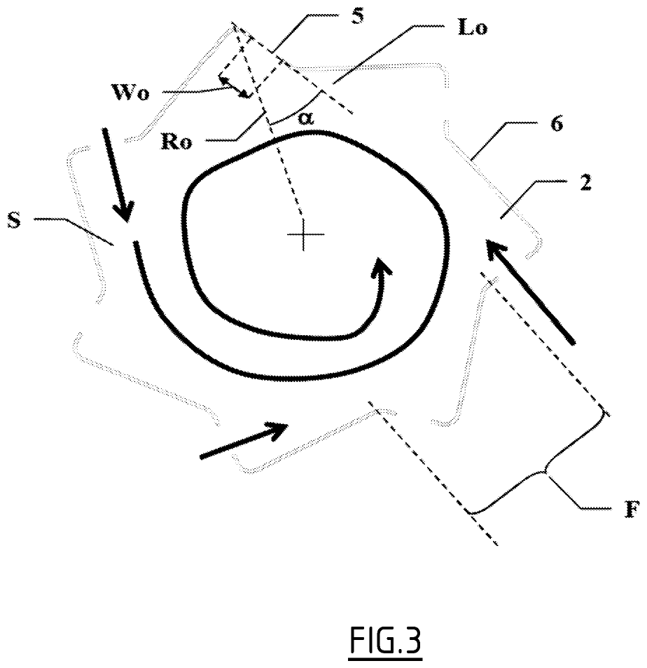

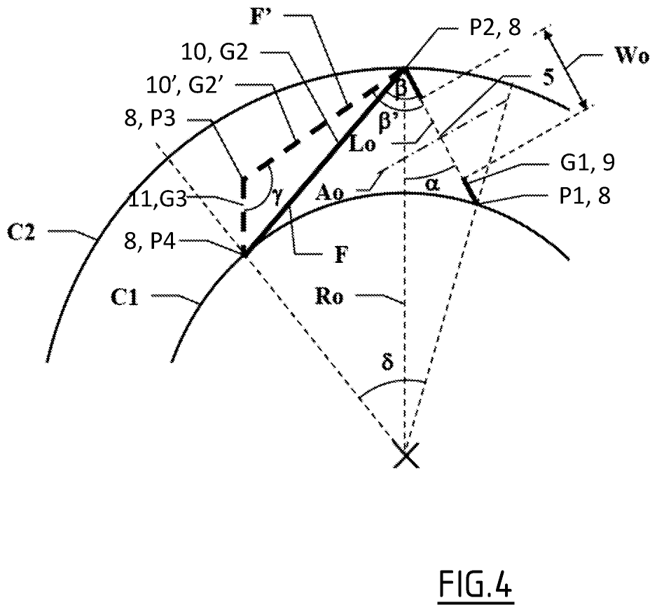

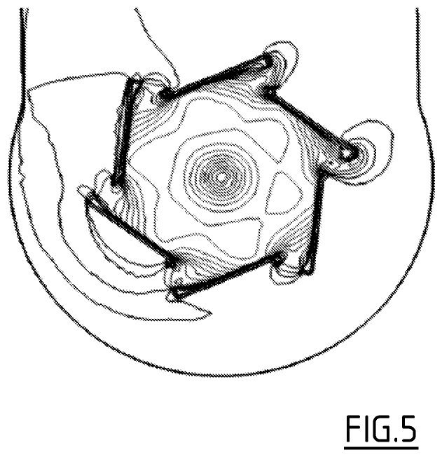

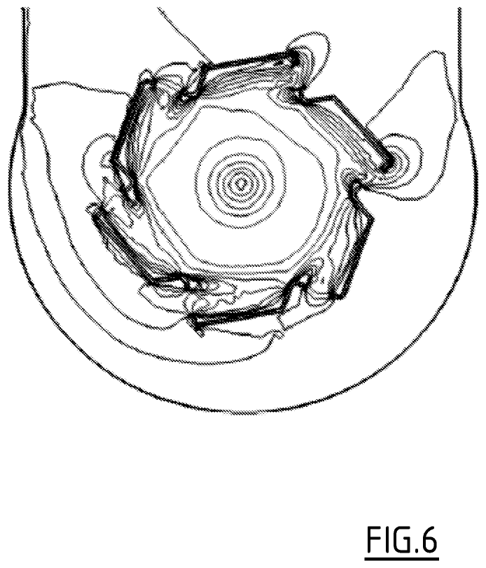

More specifically, in reference to FIGS. 3 and 4, said star-shaped section S is obtained by polarly periodically repeating an elementary profile F, F′. Said elementary profile F, F′ comprises an opening 5 oriented along a first angle α relative to a radius. In other words, a first segment G1 passing through the two ends of said opening 5 is oriented by a first angle α relative to a radial line Ro, starting from the center of said section S, or from the axis Am, and passing through the distal end P2 of said first segment G1. The opening 5 is also defined by its width Wo. The line Lo is a straight line coupling the two ends of said opening 5 and thus supporting said first segment G1.

According to one important feature, said elementary profile F, F′ substantially comprises only straight segments G1, G2, G2′, G3. This feature makes it possible to simplify the manufacture of the mixing chamber 2, by folding a flat blank, as explained earlier. Above all, this allows the elementary profile F, F′ and therefore the section S to be defined by few parameters: respective lengths of the segments G1, G2, G2′, G3 and respective angles α, β, γ between these segments G1, G2, G2′, G3. The word “substantially” means here that bending radii are allowed, as an exception, between the successive segments G1, G2, G2′, G3.

It has been seen that an elementary profile F, F′ is polarly periodically repeated. In reference to FIG. 4, it can be seen that this means that an elementary profile F, F′ extends over an angle δ equal to 360°/N, with N the integer number of periodic repetitions.

According to one feature of the disclosure, said number N of periodic repetitions is between 2 and 20, preferably between 4 and 16, still more preferably between 6 and 12. The number N is a compromise. The larger N is, the more the vortex can be polarly uniform. The smaller N is, the simpler the manufacture of the mixing chamber is. In other words, a minimal value of N is necessary in order to obtain the uniformity of the swirling flow. But an additional increase of N is limited by the constraints of the manufacturing method.

Advantageously, the number N is a prime number. This feature is linked to the management of the noise. A prime number N leads to greater wavelengths, and thus to a potential reduction in noise. Among the prime numbers in the selected intervals, the two prime numbers 7 and 11 are preferred.

The first angle α determines the orientation of the opening 5 and thus the shape and the intensity of the vortex when the gas enters the mixing chamber 2. The first angle α is between 0 and 90°, preferably between 10 and 80°, still more preferably between 15 and 50° and even more preferably between 15 and 45°. This first angle α makes it possible to manage the swirling speed by separating the entry velocity at the opening 5, closely coupled to the width Wo of the opening, and the rotation speed. In particular, the mass flow rate speed equilibrium at the opening 5 could be improved by reducing the total width Wo of the opening 5. This increases the swirling speed. This can be counterbalanced by increasing the angle α. This example shows how the angle α can adjust the rotation speed of the vortex.

An extreme angle of 90° causes an injection of the flow along a purely radial direction and therefore without producing a vortex. Since a vortex is functionally required, a 90° angle is not appropriate.

According to another feature, the first segment G1 of the elementary profile F comprises the opening 5. Preferably, the first segment G1 is aligned with the opening 5. So as to massively allow the gas to enter the mixing chamber 2, the width Wo of the opening must be maximized. As a result, the length of the first segment G1 is substantially equal to the width of the opening 5, within the limits of the manufacturing constraints. Thus, the distal end P2 of the first segment G1 nearly coincides with one end of the opening 5, while the proximal end P1 of the first segment G1 nearly coincides with the other end of the opening 5.

In reference to FIG. 4, an elementary profile F, F′, made up of segments G1, G2, G2′, G3, is defined by points P1-P4. P1 is the first point. The bipoint (P1, P2) defines the first segment G1. The bipoint (P2, P3) defines the second segment G2. The bipoint (P2, P4) defines an alternative second segment G2′. The bipoint (P3, P4) defines the third segment G3. A bending radius, not shown, can be present at each of these points P1-P4.

The first point P1 and the last point P4, due to the periodic repetition, must be located on the edges of the angle δ and at the same distance from the center/from the axis Am, or both located on a same circle C1. The furthest point, whether it is P2 or P3, is located on a largest circumscribed circle C2, with the same center, such that the elementary profile F, F′ forms one branch of the star.

In addition to the first segment comprising the opening 5, the elementary profile F must also comprise a second segment G2, G2′. Said second segment G2, G2′ is adjacent (and coupled by P2) to the first segment G1 and oriented relative to said first segment G1 by a second angle β, β′.

The second angle β determines the orientation of a segment G2/wall that is opposite relative to the opening 5. Said G2/wall segment contributes to guiding the gas flow toward the center/axis Am, and thus conditions the shape and the intensity of the vortex. This second angle β is between 45 and 90°, preferably between 60 and 90°, still more preferably between 70 and 90° when the elementary profile F comprises two segments G1, G2.

With only two segments G1, G2, it is possible to design a star branch. In such a case, said star branch is triangular and the angle β is determined by the geometry.

Alternatively, the elementary profile F′ can also comprise a third segment G3. Said third segment G3 is adjacent (and coupled by β) to the third segment G2 and oriented relative to the second segment G2 by a third angle γ. F in continuous lines illustrates an elementary profile F with two segments G1, G2. F′ in dotted lines illustrates an elementary profile F′ with three segments G1, G2′, G3, the first segment G1 being the same.

The second angle β′ determines the orientation of an opposite G2′/wall segment, relative to the opening 5. Said G2′/wall segment again contributes to guiding the gas flow toward the center/axis Am, and thus conditions the shape and the intensity of the vortex. This second angle β′ is between 45 and 180°, preferably between 80 and 180° and still more preferably between 90 and 180°, when the elementary profile F′ comprises more than two segments G1, G2′, G3.

The third angle γ better determines and complicates the opposite wall. The G3/wall segment more precisely defines the shape and intensity of the vortex. With only two segments G1, G2, as illustrated by the elementary profile F, this shape is constrained triangularly and the orientation of the second segment G2 is imposed. A third segment G3 allows a degree of freedom, as illustrated by the elementary profile F′, during the design of said opposite wall, and particularly the orientation of the segment G2′, while ensuring the periodicity constraint to complete the elementary profile F′, with a final point P4 on the first circle C1. The third angle is between 90 and 180°, and preferably between 100 and 180°.

Tests and simulations have been done, which show that adding a fourth or other segments does not significantly improve the adjustment capabilities of the vortex, and at least not enough to justify the corresponding additional manufacturing complexity.

FIGS. 2 and 3 illustrate a mixing chamber, the section S of which comprises seven branches with two segments.

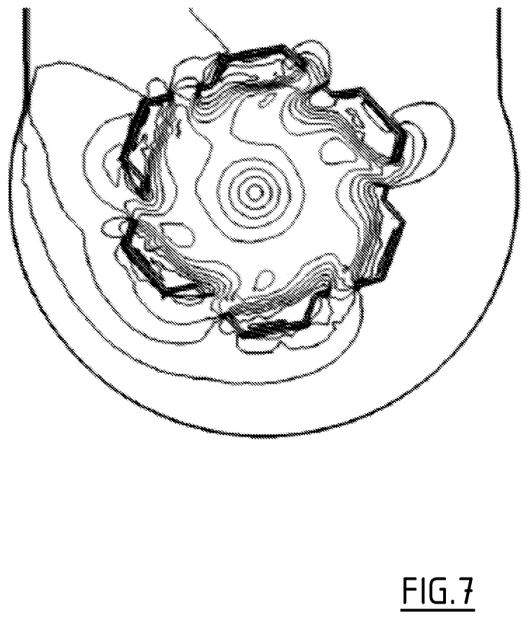

FIGS. 5, 6 and 7 illustrate three other embodiments, with a superimposed velocity diagram of the obtained gas. They all comprise six branches. The embodiment of FIG. 5 shows an elementary profile comprising two segments. The velocity diagram shows color differences (gray levels) indicative of the presence of a speed gradient in the gas flow. The embodiment of FIG. 6 shows an elementary profile comprising three segments. The first angle α is the same as in FIG. 5. The second angle β′ is close to 90°. The velocity diagram shows, in gray levels, a swirling speed. This indicates that the second segment G2′ participates in generating the vortex, but the orientation of the opening, defined by the first angle α, is the main contributor. The embodiment of FIG. 7 shows an elementary profile comprising three segments, but with angles α, β, γ different from those of the preceding embodiment. In particular, the first angle α has been reduced compared to FIG. 6. The velocity diagram shows (in gray levels) certain differences indicative of a speed gradient, both radial and polar, in the gas flow. It further shows a slower swirling speed compared to FIG. 6.

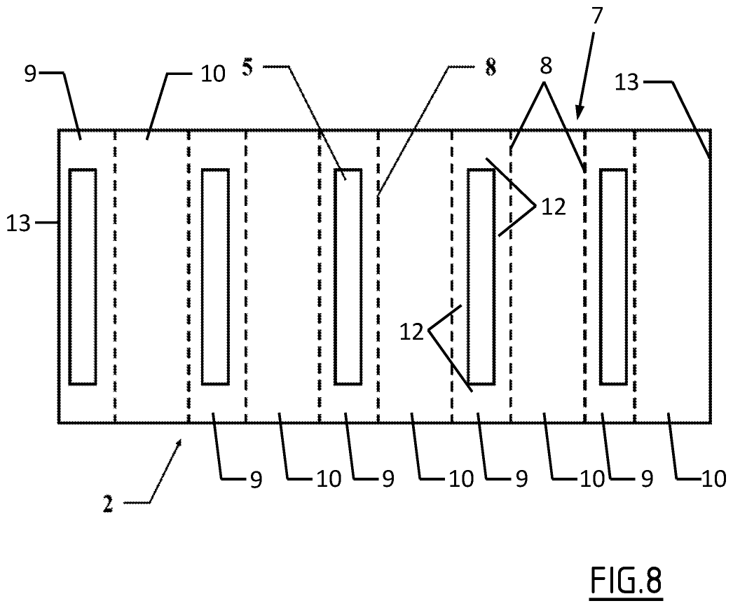

One important advantage related to the fact that the elementary profile F, F′, and thus the section S, is made up of rectilinear segments G1, G2, G2′, G3, is that the generatrix surface 6 of the mixing chamber 2 can be manufactured simply from a single metal sheet or blank. As illustrated in FIG. 8, said blank, which is substantially rectangular, is cut in order to obtain the openings 5 and bent rectilinearly, along the dotted lines 8, corresponding to the points P1-P4, in order to form the segments G1, G2, G2′, G3/walls. The general cylindrical shape is thus obtained. It is completed by assembling the two ends facing one another, so as to close the generatrix surface 6.

Thus, the generatrix surface 6 is a side wall radially delimiting the mixing chamber 2 and having said general cylinder shape obtained by translating said section S shaped in a star along the first axis Am.

It has said star-shaped section over its entire axial length.

The radial direction is taken from the central axis of the generatrix surface 6, which is the first axis Am, as visible in FIG. 1.

The generatrix surface 6 radially delimits the mixing chamber 2 over at least 80% of an axial length of the mixing chamber 2, preferably over at least 90% of said axial length and typically over 100% of said axial length. Said axial length is taken between the first axial end 3 and the second axial end 4.

The fact that the star-shaped profile S is obtained by periodically polarly repeating the elementary profile F, F′ means that the star-shaped profile is made up of a plurality of elementary profiles F, F′ that are all identical, juxtaposed with one another along a circle. The center of this circle is located on the central axis of the generatrix surface and constitutes the pole of the star-shaped profile. Each elementary profile F, F′ is deduced from the previous one by rotation about the pole.

The generatrix surface 6 has said section S shaped in a star over at least 80% of an axial length of the mixing chamber 2, preferably over at least 90% of said axial length and typically over 100% of said axial length.
The generatrix surface 6 is made up of several flat faces 9, 10, 11, connected to one another by bending lines (FIGS. 4 and 8).
The bending lines are lines 8 shown in FIG. 8.

The bending lines 8 are substantially parallel to the first axis Am.

Each face 9, 10, 11 extends over substantially the entire length of the generatrix wall 6.

Thus, each segment G1, G2, G2′, G3 of each elementary profile F, F′ of the star-shaped section S is defined by one of the faces 9, 10, 11.

The generatrix surface 6 comprises faces of three types (faces 9, 10′ and 11) or of two types (faces 9 and 10) depending on whether the profile has three or two segments.

The faces 9 define the first segments G1, the faces 10 define the second segments G2, the faces 11 define the third segments G3, and the faces 10′ define the second segments G2′.

The positions of the faces of a same type (9, 10, 10′ or 11) are deduced from one another by rotation about the central axis Am of the mixing chamber 2.

The faces 9 and 10 form the angle β between them, the faces 10′ and 11 form the angle γ between them, and the faces 9 and 10′ form the angle β′ between them. Each face 9 forms an angle α with the radial plane passing through the bending line 8 connecting said face 9 with the face 10 or the corresponding face 10′.

Each opening 5 is cut entirely in one of the faces, here the face 9.

It is delimited by edges 12 belonging to said face.

Each opening 5 extends over at least 80% of the axial length of said face, preferably at least 90% of said axial length. It extends over at least 50% of the width of said face taken perpendicular to the central axis Am, preferably at least 60% of said width, still more preferably at least 70% of said width.

Thus, it is quite easy to vary the orientation of the opening 5 relative to the corresponding radial plane, that is to say, the angle α. To that end, it suffices, during the manufacture of the generatrix surface, to vary the bending angles between the faces 9, 10, 10′ and 11.
Also as a result, it is possible to vary the angle α over a vast angular range, practically between 0 and 90°.
The disclosure further relates to an exhaust line comprising such a mixer 1.
The disclosure also relates to a vehicle comprising such an exhaust line.

The disclosure also relates to a method for manufacturing a mixer as described above.

The method comprises a step for manufacturing the generatrix surface 6, including the following operations:

i. obtaining a sheet of metal 7 having two opposite edges 13;

ii. cutting openings 5 in said sheet of metal 7;

iii. bending the cut sheet of metal 7 to form the segments G1, G2, G2′ G3, the two opposite edges 13 extending one along the other after the bending;

iv. assembling the two opposite edges 13 to one another.

The sheet 7 is shown in FIG. 8.

The two opposite edges 13 are typically straight edges, which will be parallel to the central axis Am after bending.

The openings 5 are cut using any suitable method, for example by stamping, laser cutting, etc.

The bending is done along the bending lines 8 described above. It makes it possible to form the faces 9, 10, 10′, 11. It makes it possible to form the elementary sections F, F′ and the star-shaped section S.

The assembly of the opposite edges 13 to one another is done by any suitable method, for example by welding.

The disclosure has been illustrated and described in detail in the drawings and the preceding description. The latter must be considered to be illustrative and provided as an example, and not as limiting the disclosure to this description alone. Many embodiment variants are possible.

### LIST OF REFERENCES

1: mixer,
2: mixing chamber,
3: first axial end,
4: second axial end,
5: opening,
6: generatrix surface,
7: inlet line,
8: bending line,
Am: axis of the mixing chamber, center of the section,
S: section,
F, F′: elementary profile,
G1, G2, G2′, G3: elementary profile segments,
α: orientation of the opening,
β, β′, γ: angles between segments,
P1-P4: definition points of an elementary profile,
δ: periodicity angle,
N: number of periods,
Ro: radius,
Lo: line passing through the opening,
Wo: width of the opening,
Ao: axis of the opening,
C1, C2: circles.

1. A mixer for mixing a fluid solution with a gas, comprising:
a mixing chamber with a general cylinder shape obtained by translating a polarly periodic section along a first axis, where the fluid solution is sprayed in the mixing chamber by a first axial end thereof, the gas enters the mixing chamber through openings formed in a generatrix surface of said mixing chamber, and a mixture exits through a second axial end opposite the first axial end, and wherein said polarly periodic section is shaped in a star, obtained by polarly periodically repeating an elementary profile, comprising an opening defined by a first angle between a first segment passing through two ends of said opening and a radial line passing through a distal end of said first segment, said elementary profile comprising said first segment comprising the opening.

2. The mixer according to claim 1, where said elementary profile comprises substantially only rectilinear segments.

3. The mixer according to claim 1, where a number of periodic repetitions is between 2 and 20.

4. The mixer according to claim 3, where said number is a prime number.

5. The mixer according to claim 1, where said first angle is between 0 and 90°.

6. The mixer according to claim 1, where said elementary profile further comprises a second segment, adjacent to the first segment and oriented relative to said first segment by a second angle.

7. The mixer according to claim 6, where said second angle is between 45 and 90° when the elementary profile comprises two segments.

8. The mixer according to claim 6, where said elementary profile further comprises a third segment, adjacent to the second segment and oriented relative to said second segment by a third angle.

9. The mixer according to claim 8, where said second angle is between 45 and 180° when the elementary profile comprises more than two segments.

10. The mixer according claim 8, where said third angle is between 90 and 180°.

11. The mixer according to claim 1, where the generatrix surface is manufactured from a single sheet of metal, cut to obtain the openings, bent to form the first segment and assembled edge to edge in order to close the generatrix surface.

12. The mixer according to claim 1, where the generatrix surface is a side wall radially delimiting the mixing chamber and having said general cylinder shape obtained by translating said polarly periodic section shaped in a star along the first axis.

13. The mixer according to claim 12, where the generatrix surface has a star-shaped section over at least 80% of an axial length of the mixing chamber, said axial length being taken between the first axial end and the second axial end.

14. The mixer according to claim 13, where the generatrix surface is made up of several flat faces, connected to one another by bending lines, each segment of each elementary profile of the star-shaped section being defined by one of the flat faces.

15. The mixer according to claim 14, where the bending lines are substantially parallel to the first axis, each flat face extending over substantially an entire length of the generatrix surface.

16. The mixer according to claim 15, where each opening is cut entirely in one of the flat faces.

17. An exhaust line comprising a mixer according to claim 1.

18. A vehicle comprising an exhaust line according to claim 17.

19. A method for manufacturing a mixer according to claim 1, the method comprising a step for manufacturing the generatrix surface, including the following operations:
obtaining a sheet of metal having two opposite edges;
cutting openings in said sheet of metal;
bending cut sheet of metal to form the first segment, the two opposite edges extending one along the other after the bending;
assembling the two opposite edges to one another.
